(19) United States
(12) Patent Application Publication
(10) Pub. No.: US 2017/0114612 A1
(43) Pub. Date: Apr. 27, 2017

(54) APPARATUS WITH PRESSURE COMPENSATING MEANS

(71) Applicant: Mirage Subsea Inc., Houston, TX (US)

(72) Inventor: Randolph Dale Lewkoski, Shiner, TX (US)

(21) Appl. No.: 14/921,305

(22) Filed: Oct. 23, 2015

(51) Int. Cl. E21B 41/00; B25B 23/145; B25B 21/00

(52) U.S. Cl. CPC E21B 41/0007; B25B 21/002; B25B 23/145

(57) ABSTRACT

Various examples of the disclosure relate to an apparatus comprising: a housing configured to enclose at least a portion of one or more components that at least partially pass through the housing; one or more seals configured to provide a seal between the housing and the enclosed portion of the one or more components, thereby defining a sealed chamber between the housing and the enclosed portion of the one or more components; a pressure compensating device configured to adjust a pressure internal of the sealed chamber, wherein the pressure compensating device is configured to be driven by a pressure differential between a pressure internal of the sealed chamber and an ambient pressure.

### FIELD

Examples of the present disclosure relate to an apparatus with pressure compensating means. Some examples, though without prejudice to the foregoing, relate to a module for a subsea torque tool and certain particular examples relate to a subsea manual torque tool.

### BACKGROUND

Typically, where certain components, such as those made from carbon steel or alloy steel, are used underwater, they must be protected from the corrosive effects of salt water. This may be accomplished by installing these components in an oil filled housing. However, it is difficult to get all of the air out of the housing. When submerged to great depths, any air inside the housing gets compressed which may enable salt water to enter the housing. A pressure compensation system may be used to supply additional oil to the housing to compensate for the compressed air. Such compensation systems typically require separate units connected to the housing externally, either directly or via hoses/cabling, and may be easily damaged. Moreover, they may hinder the movement and operation of the subsea device. Hence conventional pressure compensation systems are not always optimal.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

According to various but not necessarily all examples of the disclosure there is provided an apparatus comprising:

a housing configured to enclose at least a portion of one or more components that at least partially pass through the housing;

one or more seals configured to provide a seal between the housing and the enclosed portion of the one or more components, thereby defining a sealed chamber between the housing and the enclosed portion of the one or more components;

a pressure compensating device configured to adjust a pressure internal of the sealed chamber, wherein the pressure compensating device is configured to be driven by a pressure differential between a pressure internal of the sealed chamber and an ambient pressure.

According to various but not necessarily all examples of the disclosure there is provided a method comprising:

housing means configured to enclose at least a portion of one or more components that at least partially pass through the housing means;

sealing means configured to provide a seal between the housing means and the enclosed portion of the one or more components, thereby defining a sealed chamber between the housing means and the enclosed portion of the one or more components;

pressure compensating means configured to adjust a pressure internal of the sealed chamber, wherein the pressure compensating means is configured to be driven by a pressure differential between a pressure internal of the sealed chamber and an ambient pressure.

According to various but not necessarily all examples of the disclosure the apparatus may be provided as one or more of: a subsea device, a module of a subsea torque tool, a subsea torque tool, and a subsea manual torque tool.

The foregoing and other objects, features, and advantages of the invention will become more apparent from the following detailed description, which proceeds with reference to the accompanying figures.

### BRIEF DESCRIPTION OF THE DRAWINGS

For a better understanding of various examples of the present disclosure that are useful for understanding the detailed description and certain embodiments of the invention, reference will now be made by way of example only to the accompanying drawings in which:

FIG. 1 schematically illustrates an apparatus in accordance with the present disclosure;

FIGS. 2A and 2B schematically illustrate a cut through sectional view and a side end on view of a further apparatus in accordance with the present disclosure;

FIGS. 3A, 3B, 4A and 4B schematically illustrate sealing means suitable for use with apparatuses of the present disclosure;

FIGS. 5A and 5B schematically illustrate a cross-sectional view and an end on side view of a further apparatus in accordance with the present disclosure;

FIGS. 6A and 6B illustrate a subsea manual torque tool in accordance with the present disclosure and an exploded diagram of the same;

FIGS. 7 and 8 illustrate a pressure compensation means of the subsea manual torque tool of FIGS. 6A and 6B, and an exploded diagram of the same; and

FIGS. 9 and 10 illustrate a further pressure compensation means of a subsea manual torque tool, and an exploded diagram of the same, of an apparatus in accordance with the present disclosure.

The Figures are not necessarily to scale. Certain features and views of the figures may be shown schematically or exaggerated in scale in the interest of clarity and conciseness. For example, the dimensions of some elements in the figures may be exaggerated relative to other elements to aid explication. Similar reference numerals are used in the Figures to designate similar features. For clarity, all reference numerals are not necessarily displayed in all figures.

### DETAILED DESCRIPTION

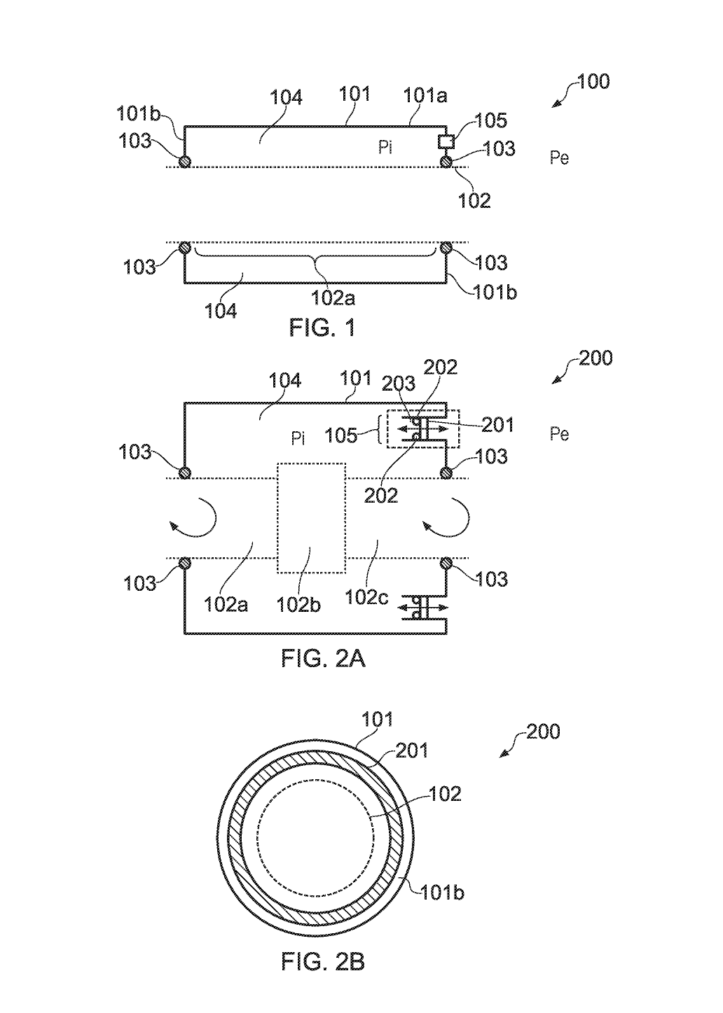

Examples of apparatuses according to the present disclosure will now be described with reference to the Figures. FIG. 1 focuses on the functional components necessary for describing the operation of the apparatus. The component blocks of FIG. 1 are functional and the functions described may or may not be performed by a single physical entity. Accordingly, the blocks support: combinations of means configured to provide the specified functions; one or more devices/assemblies configured to provide the functionality.

FIG. 1 schematically illustrates an apparatus 100 comprising a housing means 101 configured to enclose at least a portion 102a of one or more components 102 that at least partially pass through the housing means. The housing means also comprises sealing means 103 configured to provide a seal between the housing means and the enclosed portion 102a of the one or more components 102, thereby defining a sealed chamber 104 between the housing means and the enclosed portion 102a of the one or more components 102.

The housing means also comprises pressure compensating means 105 configured to adjust a pressure pᵢ internal of the sealed chamber 104. The pressure compensating means 105 is configured to be driven by a pressure differential between a pressure pᵢ internal of the sealed chamber 104 and an ambient/external pressure pₑ.

The housing means may, for example, comprise a single housing or a housing assembly of a plurality of housing members. In certain examples, the housing means may take the form of a generally cylindrical tube shaped member. Such a generally cylindrical tube shaped member may comprise a circumferential wall 101a and side walls 101b at each end, the side walls 101b having an aperture to enable the passage of the at least a portion 102a of the one or more components 102 therethrough.

The one or more components 102 that are housed within the housing means and/or at least partially pass through the housing may, in certain examples, comprise one or more of:

one or more shafts for transmitting torque, e.g. a shaft providing a torque input to the apparatus and a shaft for providing a toque output from the apparatus,

a torque multiplier, and

a torque limiter.

The sealing means may comprise one or more seals. In some embodiments, the one or more seals comprise sealing assemblies. The sealing means may inter-engage with the housing means and the enclosed portion 102a of the one or more components 102 to provide a hermetic seal thereby defining the sealed chamber which separates an environment internal of the sealed chamber from an environment external of the sealed chamber. The sealed chamber may be configured so as to be able to be filled with a fluid, e.g. oil, so as to provide a fluid filled chamber that surrounds the enclosed portion 102a of the one or more components 102 and separates the internal environment of the sealed chamber (e.g. oil filed) from an environment external of the sealed chamber (e.g. sea water).

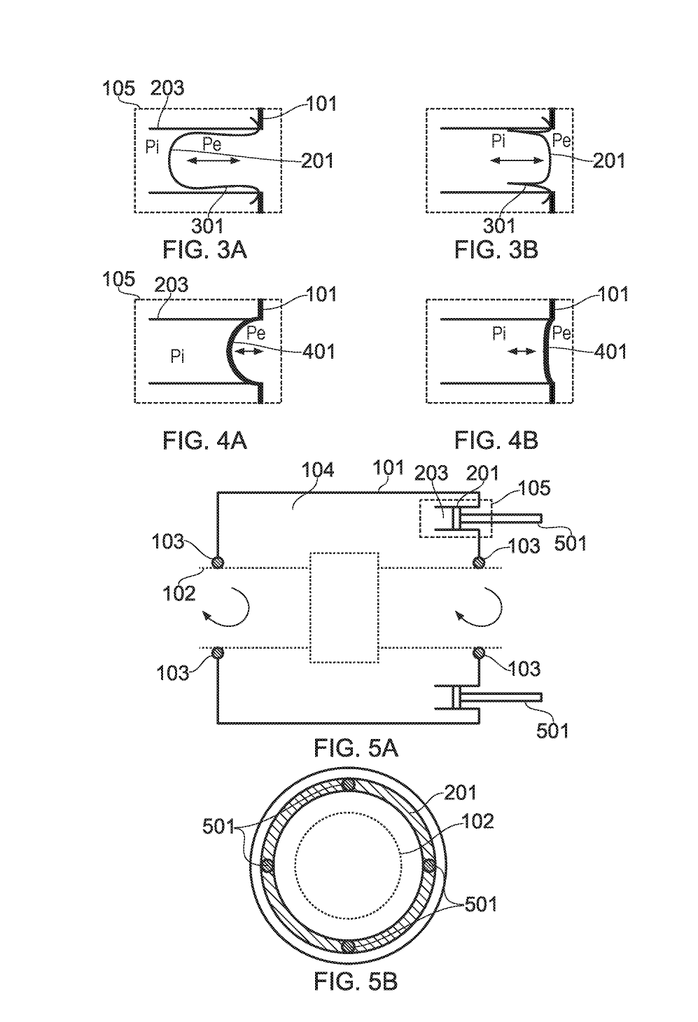

The pressure compensating means may comprise: a pressure compensator, a pressure compensating device/assembly that is configured to adjust the internal pressure of the sealed chamber and which is driven by a pressure differential between a pressure internal of the sealed chamber and an ambient pressure. An example of a pressure compensating means is shown in FIGS. 2A and 2B. In certain examples, the housing is configured such that, in use, it is at least substantially filled with a fluid, such as oil. The pressure compensating means may adjust the internal pressure of the sealed chamber by adjusting the amount of oil in the sealed chamber. For example by introducing/inserting additional fluid into the sealed chamber (e.g. when the apparatus descends through the water thereby compensating for the compression of any air/gas in the sealed chamber) and removing excess fluid from the sealed chamber (e.g. when the apparatus ascends through the water thereby compensating for the expansion of any air/gas in the sealed chamber). This may be done so as to seek to substantially equalise the internal pressure to that of the ambient/external pressure and also to compensate for any compression/expansion of any gasses in the sealed chamber.

The apparatus may be configured for subsea use, for example as a module of a subsea device such as a torque tool or manual torque tool that may be manipulated and operated by a Remotely Operated Vehicle (ROV). The apparatus may be provided in a module. As used here ‘module’ refers to a unit or apparatus that excludes certain parts/components that would be added by an end manufacturer or a user.

Some examples may provide the advantage that since the pressure compensating means is driven by a pressure differential between an internal pressure of the sealed chamber and an ambient/external pressure (e.g. such as a pressure differential that might arise when the apparatus is submerged to significant depths) the pressure compensation means does not require the specific provision of a dedicated driving force/source of power (e.g. provision of pressurised hydraulic fluid to drive hydraulic actuators or the provision of electricity to drive electric motors of the pressure compensation system). Thus, the apparatus, in effect, is provided with built-in stand-alone pressure compensation system that is self-driven/powered. Advantageously, examples may avoid the need for a hydraulic/electrical system and hydraulic hoses/electrical cabling for powering and driving the pressure compensation means. Thus, a simplified pressure compensation system may be provided that does not require a dedicated source of hydraulic pressure/electricity and moreover does not require attachment or connection to hydraulic hoses or electrical cabling, thereby facilitation operation and use of the apparatus.

FIGS. 2A and 2B schematically illustrate a block diagram of a further apparatus 200 according to the present disclosure. In the apparatus 200, the pressure compensating means 105 comprises a moveable member 201 configured such that movement of the moveable member adjusts the pressure internal of the sealed chamber 104. The moveable member is configured such that the pressure differential between the internal pressure pᵢ and the ambient/external pressure pₑ drives movement of the moveable member. Further sealing means 202 may be provided and configured to dynamically seal the moveable member, thereby separating an environment internal of the sealed chamber (e.g. the oil filled housing) from an environment external of the sealed chamber (e.g. sea water).

The pressure compensating means also comprises a further chamber 203 an inner side of which is in fluid communication with the sealed chamber 104. The moveable member is moveably located within the further chamber. An outer side of the moveable member is in fluid communication with the ambient environment such that a pressure differential between an internal pressure and the ambient pressure gives rise to a force on the moveable member to cause movement of the moveable member within the further chamber. In such a manner, the moveable member may, in effect, be hydraulically driven by the pressure differential.

The further sealing means may comprise one or more seals, not least for example: a piston seal, a lip seal, an O-ring seal, a diaphragm/bellows, and a rolling diaphragm.

The further sealing means 202 is configured to dynamically seal the moveable member within the further chamber so as to enable movement of the moveable chamber within the further chamber of maintaining a seal between the moveable member and the further chamber. The further chamber may itself be fluid filled, e.g. with oil, such that movement of the moveable member in one direction forces oil from the further chamber into the sealed chamber, thereby increasing the internal pressure, whereas movement in an opposite direction may draw out oil from the sealed chamber into the further chamber thereby reducing the internal pressure of the sealed chamber. Thus, movement of the moveable member within the further chamber displaces fluid between the sealed chamber and the further chamber thereby adjusting the internal pressure of the sealed chamber.

The apparatus 200 may be configured so as to enable movement of some of the one or more of the components 102 relative to the housing means 101. For example, the enclosed components that pass through the housing means, such as an input shaft 102c and output shaft 102a may be rotatable relative to the housing means, as indicated by the arrows of FIG. 2A. The sealing means 103 may be duly configured so as to enable dynamic sealing of the moveable portions of the components thereby maintaining a separation of an environment internal of the sealed chamber from an environment external of the sealed chamber.

In certain examples of the disclosure, the one or more components 102 that pass through and/or are housed within the housing 101 are devices configured so as to receive an input torque and provide an output torque. The one or more components within the housing may comprise one or more of: torque transmitting means such as a shaft 102a, 102c, torque multiplying means such as a torque multiplying mechanism 102b, and torque limiting means such as a torque limiting mechanism/clutch (not shown).

Such examples of the apparatus may be configured so as to provide a subsea tool such a subsea torque tool and a subsea manual torque tool.

The housing may have a generally circular circumference with a central circular aperture therethrough enabling the passage of one or more components therethrough, i.e. such that components or parts of components may be occupy an interior central volume of the housing. The pressure compensating means may comprise a ring/toriodal shaped movable member within a ring/toriodal shaped further chamber such that the components 102 can pass through/occupy a central area of the pressure compensating means.

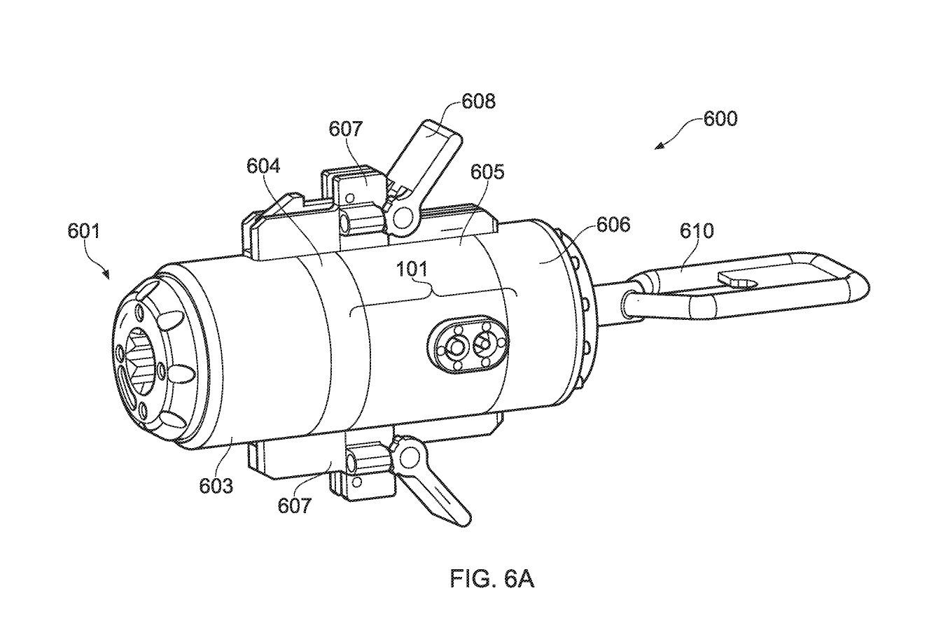

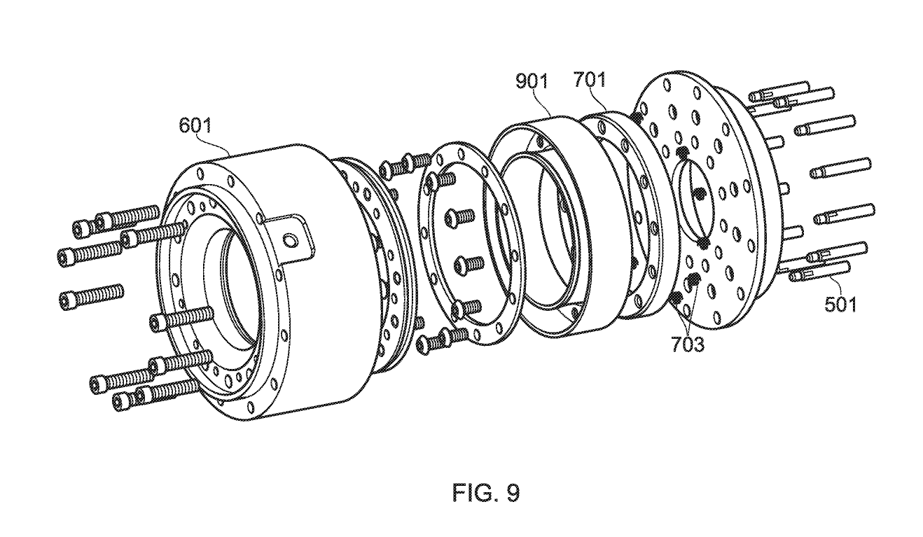

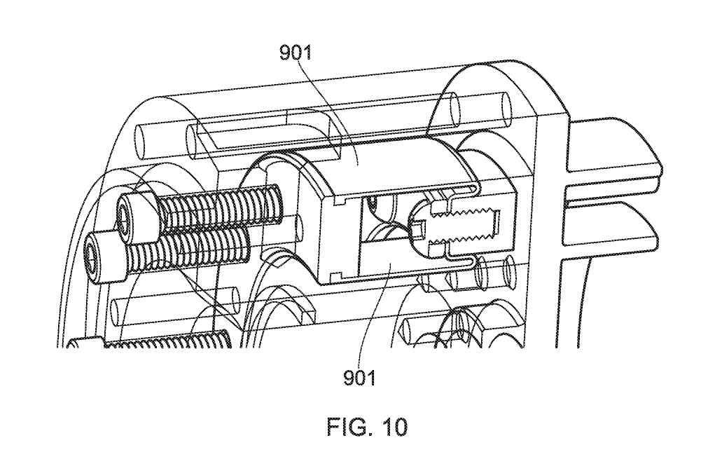

The moveable member may be a part of the sealing means itself. For example instead of having a separate moveable member and further sealing means, the moveable member can be coupled to the sealing means such that at least a portion of the two elements are fixed to one another. In some embodiments, the moveable member can be fixed to the sealing means by being formed as an integral part of the sealing means. In one embodiment, the further sealing means can correspond to a piston seal (as shown in FIGS. 7 and 8). Alternatively, the sealing means could correspond to a rolling diaphragm 301 as shown in FIGS. 3A and 3B as well as FIGS. 9 and 10.

FIGS. 3A and 3B schematically illustrate an alternative pressure compensation system 105 to that of FIGS. 2A and 2B, that uses a rolling diaphragm 301 instead of the moveable member 201 and the further sealing means 202 of FIGS. 2A and 2B.

In FIG. 3A, where the ambient/external pressure pₑ exceeds that of the internal pressure pᵢ (such as would occur when the apparatus is submerged) the pressure differential Δp forces the rolling diaphragm 301 inwards towards the further chamber 203 into an extended configuration which reduces the volume of the further chamber 203 thereby displacing any fluid/oil previously therein into the sealed chamber 204 thereby adding/inserting/injecting oil to the sealed chamber and increasing its internal pressure so as to seek to compensate/equalise the pressure differential. In FIG. 3B, when the apparatus is at a lesser depth/removed from the water, the internal pressure may cause the rolling diaphragm into a folded configuration as shown in FIG. 3B thereby increasing the internal volume of the further chamber enabling it to draw in oil from the oil filled sealed chamber thereby reducing the internal pressure.

FIGS. 4A and 4B illustrate an alternative further sealing means of the pressure compensation system 105, wherein the sealing means comprises a diaphragm or bellows 401 which can move so as to expand/contract in dependence on the pressure differential Δp thereby increasing/decreasing a displaced volume of the further chamber 203 causing the addition/removal of oil to/from the sealed chamber 104.

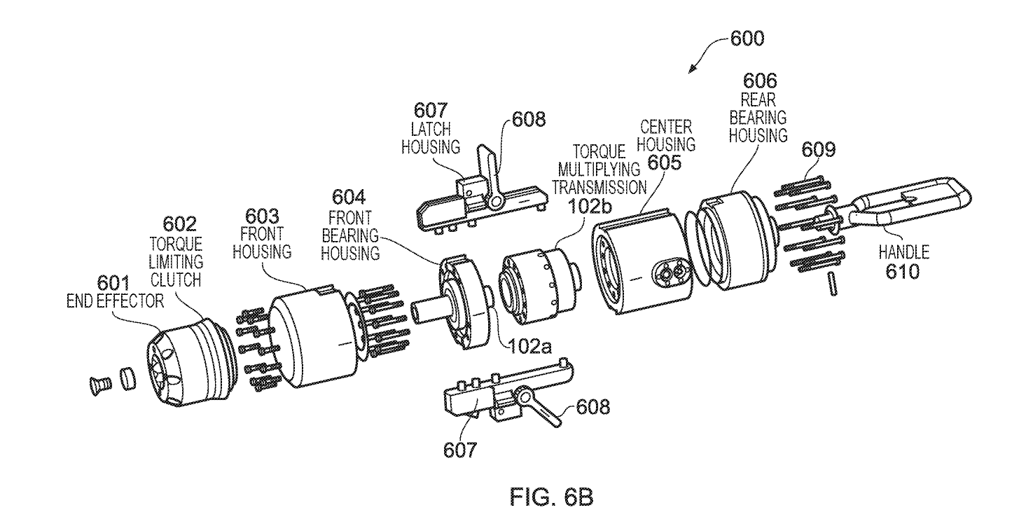

FIGS. 5A and 5B show an apparatus 500 further comprising indicating means 501 configured to indicate movement of the moveable member. Since, in certain examples, the moveable member 201 is located within the further chamber 203, which itself may reside within the sealed chamber, the moveable member may not be readily visible. The indicating member 201 may correspond to an elongate rod attached to or indirectly coupled to the moveable member such that movement of the moveable member causes corresponding movement of the elongate rod which projects outwardly of the housing thereby being visible externally of the housing and indicating movement of the moveable member. For example, where an ROV is using the apparatus, the ROV may comprise a video camera that can observe movement of the indicating member 201. With this arrangement, the position of the moveable member/seal can be monitored by observing the position of the rods. This can be used to monitor leakage of oil from the chambers, e.g. where the position(s) of the indicating means have been pre-calibrated.

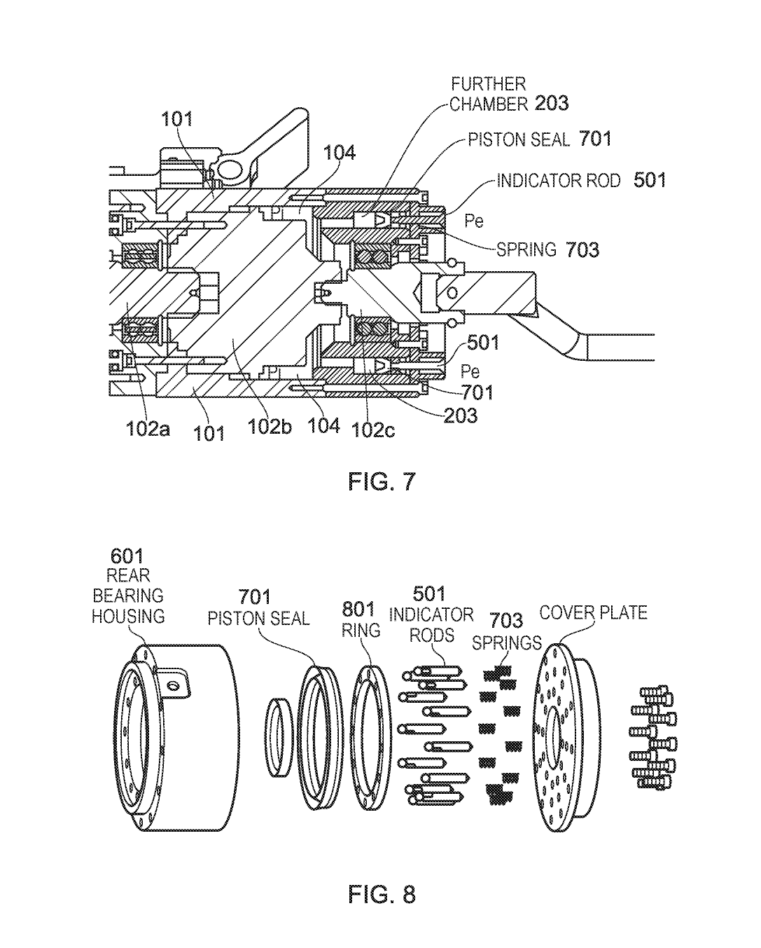

FIG. 6A illustrates an example of a subsea manual torque tool 600 in accordance with the present disclosure. The subsea manual torque tool 600 comprises:

a) an end effector 601 (e.g. driving socket) designed to engage on a member/shaft that is to be rotated by the torque tool.
b) a torque limiting clutch 602. This may be pre-calibrated to a determined torque limit e.g. 500 lbs-ft (678 Nm). The torque limiting clutch prevents too great a torque being outputted and provided to the end effecter and thus limits the torque applied to the object to be rotated. For example, where the object to be rotated is a valve shaft, this may prevent the valve shaft from being twisted off.
c) a front housing 603 configured to protect the end effector and torque limiting clutch as well as providing a guiding surface for engaging the torque tool into a standard torque tool bucket.
d) a front bearing housing 604 which contains the sealing means 103 for sealing oil within the housing 101. The front bearing housing may also comprise a component 102a which passes through the housing, in this case a double row ball bearing and output shaft.
e) a centre housing 605 which contains a further component 102a housed within the housing 101, in this case a torque multiplying transmission. The torque multiplying transmission enables a typical ROV manipulator to have sufficient force to operate valves at a higher torque requirement than the manipulator may normally be able to provide, for example by rotating wrist movement the ROV manipulator. This may also slow the output movement down significantly such that it can be easily observed, for example via a video camera attached to the manipulator.
The centre housing also comprises various plumbing that enables the housing to be filled with oil and enable the venting off of air.
f) a rear bearing housing 606 that contains further sealing means 103 for sealing oil within the housing as well as a further component that passes through the housing, in this case a double row ball bearing and input shaft. The internal compensation system 105 is also contained in the rear bearing housing. As discussed above, this compensates for any air that may be in the oil filled housing 101, i.e. housing members 604, 605 and 606. (As will be appreciated, the housing means 101 of FIG. 1 corresponds to: the front bearing housing 604, the centre housing 605 and the rear bearing housing 606. The one or more components 102 that at least partially pass through and/or are housed within the housing correspond to: the output shaft, the torque multiplying transmission and the input shaft). g) latch housing 607 which provides a reaction point to resist torque, i.e. when the tool is inserted into a torque tool bucket. In certain examples of the tool, latches may not be required, for example when removing a chemical injection metering valve from a well, however, in other applications, latches may be required.
h) spring loaded latches 608 that retain the tool 600 in a torque bucket when required. The spring loaded latches may be manually operated, e.g. via slap handles, onto latched and unlatched modes of operation. Such manual latches eliminate the need for hydraulic actuation of the latches and further avoiding the need for hydraulic power to operate the torque tool.
i) a handle 610 configured such an ROV may manoeuvre and manipulate the tool and rotate the input shaft so as to provide an input torque that is transmitted through the housing via the torque multiplying transmission and through the output shaft to provide an output torque to the torque limiting clutch to rotate an end effecter. The handle not only enables grasping and manipulation of the tool but also provides a means to operate the tool manually by rotating the handle so as to provide an input torque to the torque tool.

Conventional subsea torque tools are hydraulically operated and require a hydraulic ROV and associated hydraulic hoses for operation. By contrast, advantageously, the manual torque tool 600 does not require hydraulic power in order to operate nor does it require hydraulic hoses or electrical cabling e.g. via connections to the ROV. This may enable the tool to be moved around with more freedom in an unencumbered manner. For example, since hoses and cables are not required to be attached to the manual torque tool, the rotation of the handle would not give rise to any tangling of such hosing or cabling.

The torque tool shown in FIGS. 6A and 6B is a manual torque tool, i.e. an input torque is provided to the tool to provide an output torque (c.f. output torque being generated via an input hydraulic pressure or electric motors). However, in other examples, the torque tool may hydraulically driven with a hydraulic motor. Alternatively, the torque tool may be electrically driven via an electrical servo motor to drive the tool. Electrical power could be provided either via electrical cable or a remote power source or via an in-built battery pack. A controller and communication means may be provided so as to control the motor to drive the tool upon remote communication (e.g. via acoustical communication) this may enable the tool to be installed at a convenient time, e.g. in advance of this operation, and then subsequently operated, when required, without the assistance of an ROV. The tool could then subsequently be retrieved at a convenient time.

FIGS. 7 and 8 show the internal compensation system of the torque tool 600 in greater detail. A hydraulic piston seal 701 (which acts both as a moveable member 201 and the further sealing means 202) and chamber 203 for the seal 701 to reside in are provided. The seal seals on the inside and outside of the wall of the chamber. One side of the chamber is hydraulically connected to the oil filled housing 101 and the other side of the chamber is open to the ambient environment, i.e. the sea water when in use.

The seal 701 separates these two environments. When the tool is lowered through the sea, water column ambient pressure p_{c} causes any air in the housing to compress. The same ambient pressure p_{c} will also act from the outside of the seal 701 and force the seal to move thereby displacing oil from the chamber 203 into the sealed chamber 104 of the oil filled housing 101 thereby compensating for compression of any air inside the housing 101.

The reverse operation happens when the tool is recovered and ascends through the sea back to the surface. As the air inside the housing 101 expands, it forces the seal 701 to move in the opposite direction, which absorbs and stores the excess oil displaced by the expanding air. The compensation system has a metal ring 801 and an arrangement of metal rods (indicating means) 501 that protrude out of the housing 101. Biasing means, such as springs 703 may be provided and configured so as to hold the metal ring 801 against the back of the seal 701. With this arrangement, the position of the seal 701 can be monitored by observing the position of the rods 501. Moreover, from the position of the rods, it may be possible to determine whether or not any oil has been lost from the system.

Two concentric rings may surround these rods 501 in order to protect them from damage. The springs 703 only hold these rings against the seal 701 and may be configured such that they do not provide sufficient force to move the seal, i.e. due to the friction the seal has on the inner and outer walls of the chamber 203. Such a configuration can be considered as a “zero pressure” compensation system. Alternatively, the springs could be configured such that a small amount of pressure is applied to the ring 801 against the piston seal 701 so as to provide a “positive pressure compensation system”.

As previously discussed, various other forms of sealing means may be provided instead of a piston seal. For instance, instead of the piston seal of FIGS. 7 and 8, a rolling diaphragm 901 may be used as shown in FIGS. 9 and 10.

Various examples of the present disclosure may provide an apparatus that can be used on sea wells to (1) operate valves and (2) attach or remove well head components. Such components may include valves (e.g. chemical injection metering valves), flying leads. The torque tool could be used to operate anything that requires rotation to a specific amount and/or specific torque items requiring such rotation may include clamps, lifting and/or positioning devices.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

The examples of the present disclosure and the accompanying claims may be suitably combined in any manner apparent to one of ordinary skill in the art. Features described in the preceding description may be used in combinations other than the combinations explicitly described.

Although functions have been described with reference to certain features, those functions may be performable by other features whether described or not. Although features have been described with reference to certain examples, those features may also be present in other examples whether described or not. Although various examples of the present disclosure have been described in the preceding paragraphs, it should be appreciated that modifications to the examples given can be made without departing from the scope of the invention as set out in the claims. For example, in the apparatus 600 of FIGS. 6A and 6B, the torque limiting clutch 602 is placed outside of the (oil filled) housing 101, i.e. outside housing members 604, 605, 606. However, in other examples, the torque limiting clutch (and indeed other components), may be placed within the housing 101.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components).

In this description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. An apparatus comprising:
a housing means configured to enclose at least a portion of one or more components that at lease partially pass through the housing means;
one or more seals that engage with the housing means and the enclosed portion of the one or more components to define a sealed chamber between the housing means and the enclosed portion of the one or more components;
a pressure compensating device configured to adjust a pressure internal of the sealed chamber, wherein the pressure compensating device is configured to be driven by a pressure differential between a pressure internal of the sealed chamber and an ambient pressure.

2. The apparatus of claim 1 wherein the sealed chamber is configured in use, to be substantially filled with a fluid, and wherein the pressure compensation device is configured so as to be driven by the pressure differential to cause one or more of:
introducing additional fluid to the sealed chamber, and
removing fluid from the sealed chamber.

3. The apparatus of claim 1, wherein the pressure compensating means comprises a movable member, and wherein the apparatus is configured such that movement of the moveable member adjusts the pressure internal of the sealed chamber, and wherein the member is configured to be driven by the pressure differential.

4. The apparatus of claim 3 wherein the pressure compensating device further comprises one or more second seals that dynamically seal the movable member, thereby separating an environment internal of the sealed chamber from an environment external of the sealed chamber.

5. The apparatus of claim 1, wherein the pressure compensating device comprises:
a further chamber, an inner side of which is in Fluid communication with the sealed chamber, wherein the movable member is movably located within the further chamber and wherein an outer side of the movable member is in fluid communication with the ambient environment.

6. The apparatus of claim 5, wherein the sealed chamber is configured, in use, to contain a fluid, wherein the further chamber is configured, in use, to contain a fluid, and wherein the apparatus is configured such that movement of the moveable member within the further chamber displaces fluid between the sealed chamber and the further chamber thereby adjusting the pressure internal of the sealed chamber.

7. The apparatus of claim 4, wherein the one or more second seals are coupled to the moveable member.

8. The apparatus of claim 1, wherein the pressure compensating device comprises:
a toroidal shaped chamber; and
a toroidal shaped movable member disposed within the toroidal shaped chamber, wherein the apparatus is configured such that movement of the toroidal shaped movable member is driven by the pressure differential between the pressure internal of the sealed chamber and the ambient pressure.

9. The apparatus of claim 8, wherein the toroidal shaped chamber and the toroidal shaped movable member form a ring around the at least a portion of the one or more components.

10. The apparatus of claim 3, further comprising an indicating member configured to indicate movement of the moveable member.

11. The apparatus of claim 10, wherein the indicating member comprises one or more elongate members configured to protrude from the housing, wherein the one or more elongate members are configured such that movement of the movement member moves the one or more elongate members.

12. The apparatus of claim 1, wherein the apparatus is configured so as to enable movement of the at least a portion of one or more components relative to the housing.

13. The apparatus as claimed in claim 12, wherein the one or more seals are configured to dynamically seal the movable at least a portion of the one or more components, thereby separating an environment internal of the sealed chamber from an environment external of the sealed chamber.

14. The apparatus of claim 1, wherein the apparatus is configured to receive an input torque and provide an output torque.

15. The apparatus of claim 1, further comprising, within the housing, one or more of:
a shaft configured to transmit torque,
a torque multiplying device, and
a torque limiting device.

16. An apparatus comprising:
a housing means for enclosing to at least a portion of one or more components that at least partially pass through the housing;
a sealing means for providing a seal between the housing and the enclosed portion of the one or more components, thereby defining a sealed chamber between the housing and the enclosed portion of the one or more components;
a pressure compensating means for adjusting a pressure internal of the sealed chamber, the pressure compensating means being driven by a pressure differential between a pressure internal of the sealed chamber and an ambient pressure.

17. The apparatus of claim 1, wherein the apparatus is configured for subsea use.

18. A subsea device comprising the apparatus of the previous claim 17.

19. A module of a torque tool comprising the apparatus of claim 1.

20. A sub-sea torque tool comprising the apparatus of claim 1.

21. A sub-sea manual torque tool comprising the apparatus of claim 1.
